(19) United States
(12) Patent Application Publication
(10) Pub. No.: US 2010/0245610 A1
(43) Pub. Date: Sep. 30, 2010

(54) METHOD AND APPARATUS FOR PROCESSING DIGITAL IMAGE

(75) Inventors: Hyunsang AHN, Daejeon (KR); Sang Won GHYME, Daejeon (KR); Won Seok CHAE, Daejeon (KR); Byoung Tae CHOI, Daejeon (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejeon (KR)

(21) Appl. No.: 12/415,331

(22) Filed: Mar. 31, 2009

(51) Int. Cl. H04N 5/228

(52) U.S. Cl. 348/222.1; 348/E05.031

(57) ABSTRACT

A digital image photographing method includes: recognizing a subject by analyzing an image photographed by a digital image photographing apparatus; separating the recognized subject from a background in the image; and displaying a recommending lead line of a rule of thirds on a display of the digital image photographing apparatus to help position the recognized subject on an intersection point of transversal and vertical trisectional lines. Further, the digital image photographing method includes recommending a composition, a pose and a motion which are matched to the recognized subject and the background with reference to pre-recorded information about the composition, the pose and the motion.

### FIELD OF THE INVENTION

The present invention relates to a method and an apparatus for processing a digital image, and more particularly, to an image photographing method and apparatus for providing services which allows a novice to create high quality digital contents like that of an expert cameraman.

This work was supported by the IT R&D program of MIC/IITA [2007-S051-01, Software Development for Digital Creature].

### BACKGROUND OF THE INVENTION

A popular image photographing apparatus, such a digital still camera, a digital video camera, a camera phone and the like, takes an image by recording intensity of an electric signal to a device called as a charge coupled device (CCD) or a complementary metal oxide semiconductor (CMOS) to provide various functions unable in an existing film type analog image taking system.

In the existing image photographing system, the photographed image is edited in such a way that a film containing the photographed image is directly edited or that the film is scanned and converted into a digital image by using a computer and the scanned image is edited manually with image editing software such as Adobe Photoshop, Adobe Premiere and the like.

Recent rapid increase of creating personal home pages, blogs, user created contents (UCC) and the like is causing the creation of high quality digital contents to become more professional day by day.

Existing digital image photographing apparatuses provide various functions more than those of existing analog photographing apparatuses, but do not completely satisfy demands of users who want to create the high quality image contents.

For the creation of the expert level high quality image, special functions such as an auto-focus function, an exposure compensation function, an auto-white balancing function, and the like are required in addition to functions already provided in the digital image photographing apparatus.

### SUMMARY OF THE INVENTION

In view of the above, the present invention provides an image photographing method and apparatus for providing services which allows a novice to create high quality digital contents like that of an expert cameraman.

In accordance with a first aspect of the present invention, there is provided a digital image photographing apparatus including: a photographing unit for taking an image; a recognizing unit for recognizing a subject from the image photographed by the photographing unit, wherein the recognized subject is captured in a rectangular area; an image processing unit for separating the recognized subject from a background; a recommending composition processing unit for recommending a composition, a pose and a motion matched to the recognized subject and the background which are separated from each other by the image processing unit with reference to preset information; and a display for displaying the image having the composition, the pose and the motion of the recognized subject recommended by the recommending composition processing unit.

In accordance with a second aspect of the present invention, there is provided a digital image photographing method including: recognizing a subject by analyzing an image photographed by a digital image photographing apparatus; separating the recognized subject from a background in the image; displaying a recommending lead line of a rule of thirds on a display of the digital image photographing apparatus to help position the recognized subject on an intersection point of transversal and vertical trisectional lines; and recommending a composition, a pose and a motion which are matched to the recognized subject and the background with reference to pre-recorded information about the composition, the pose and the motion.

In accordance with the method and apparatus, an image taking help function can be provided for the creation of the high quality digital contents, and information for humans and various samples of subjects are recorded to be used to photograph an image. Moreover, based on the recognized subject, a rule of thirds employing apparatus, a pose/motion recommending apparatus, a background blurring apparatus and a subject compensating apparatus can be provided.

### BRIEF DESCRIPTION OF THE DRAWINGS

The objects and features of the present invention will become apparent from the following description of embodiments, given in conjunction with the accompanying drawings, in which:

FIG. 1 is a schematic block diagram illustrating a digital image photographing apparatus in accordance with an embodiment of the present invention;

FIGS. 2A and 2B are views illustrating an example in which a rule of thirds is applied to the digital image photographing apparatus in accordance with the embodiment of the present invention, and a result image thereof, respectively;

FIGS. 3A and 3B are illustrating an example in which a pose and motion recommending function is applied to the digital image photographing apparatus in accordance with the embodiment of the present invention, and a result image thereof, respectively; and

FIG. 4 is a flowchart illustrating a digital image photographing method in accordance with an embodiment of the present invention.

### DETAILED DESCRIPTION OF THE EMBODIMENT

Hereinafter, embodiments of the present invention will be described in detail with reference to the accompanying drawings which form a part hereof.

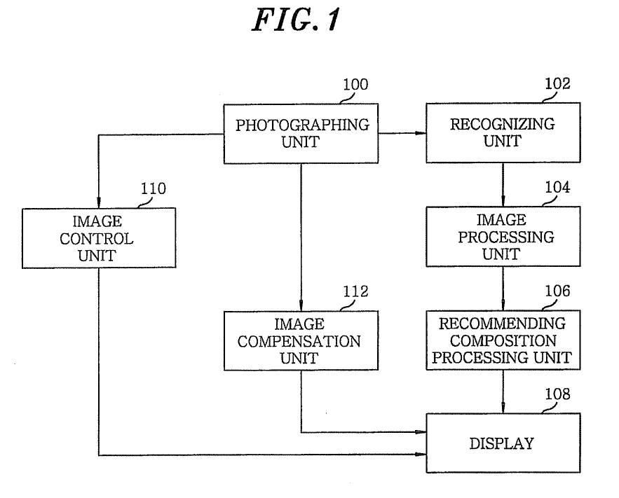

FIG. 1 shows a schematic block diagram of a digital image photographing apparatus in accordance with an embodiment of the present invention. The digital image photographing apparatus includes a photographing unit 100, a recognizing unit 102, and an image processing unit 104, a recommending composition processing unit 106, a display 108, an image control unit 110 and an image compensation unit 112.

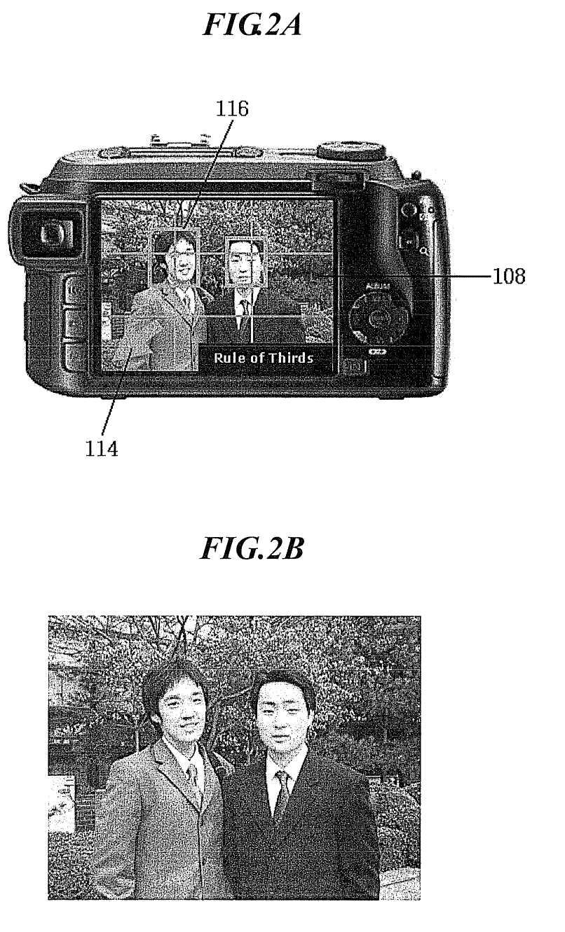

The digital image photographing apparatus, which is illustrated in FIG. 2A, has an outer appearance similar to that of a conventional photographing apparatus such as a digital camera, a digital video camera and a phone camera on the market. Thus, the digital image photographing apparatus includes all of components required in the conventional photographing apparatus to take a picture of a subject, such as a lens, a shutter, an image capturing device, a display, a flash, a storage and the like.

As illustrated in FIG. 1, the photographing unit 100 serves to photograph an image of a subject, for example, a human or a specific object. The recognizing unit 102 analyzes the image provided from the photographing unit 100 to recognize the subject in the image photographed by the photographing unit 100.

The recognition of the subject may be learned about any objects by employing a learning algorithm, e.g., an adaptive boosting algorithm and the subjects learned by the learning algorithm is stored in the digital image photographing apparatus to meet the demands of a user.

The image processing unit 104 separates a foreground (i.e., subject) from a background by using an image subtraction algorithm in a plurality of images that are photographed about a recognized region (i.e., a human face) indicated by a rectangular area 116 in FIG. 2A, and an edge detection algorithm.

The recommending composition processing unit 106 recommends a composition, and a pose and motion of the subject, which are matched to the foreground and the background separated by the image processing unit 104. According to the embodiment of the present invention, the information about the composition, the pose, and the motion, which are matched to various subjects, has been registered in the digital image photographing apparatus in advance.

Accordingly, the recommending composition processing unit 106 recommends the composition, the pose, and the motion of the subject with reference to the registered information of the subjects when the subject is photographed and recognized by the photographing unit 100.

More specifically, the recommending composition processing unit 106 displays a recommending lead line 114 indicated by an arrow in FIG. 2A on the display 108 of the digital image photographing apparatus, so that the user moves the subject along the recommending lead line 114 or move a camera to capture the subject in a rectangular area 116. In this case, the recommending lead line 114 may employ a rule of thirds.

The rule of thirds is a rule wherein a human's sight is concentrated to a point where transversal trisectional lines intersect vertical trisectional lines. When a main subject is disposed at the crossing point, a monotonous image can be avoided.

Moreover, for example, information about the transversal and vertical trisectional lines is obtained by extracting edges of the separated background and the edges are arranged parallel to the transversal and vertical trisectional lines by using the information so that an image with a stable composition can be obtained. In a case of applying the rule of thirds, when an image matched to the recommended composition is obtained while moving the camera according to determination of the recommending composition processing unit 106, even though the user does not press a shutter, the digital image photographing apparatus of the present invention photographs the image such that the image is automatically stored in the storage and is displayed to the user.

FIG. 2A is a view illustrating a process of presenting the recommending lead line in the digital image photographing apparatus of the present invention, and FIG. 2B shows an example of a result image photographed by the digital image photographing apparatus.

The display 108 displays the composition and the pose/motion of the subject, recommended by the recommending composition processing unit 106. Further, the display 108 displays the images to be processed by the image control unit 110 and the image compensating unit 112. The display 108 may include a liquid crystal display (LCD).

On the display 108 of the digital image photographing apparatus, the transversal and vertical trisectional lines are displayed to help level the digital image photographing apparatus, the recognized subject (i.e., the human face in FIG. 2A) is captured in the rectangular area 116, and a direction where the user moves his/her camera until the rectangular area 116 is positioned on the intersection point of the transversal and vertical trisectional lines is displayed by the recommending lead line 114 indicated by the arrow in FIG. 2A by applying the recommended composition considering the foreground and background.

FIG. 2B shows an example of a still image finally acquired after performance of the process illustrated in FIG. 2A.

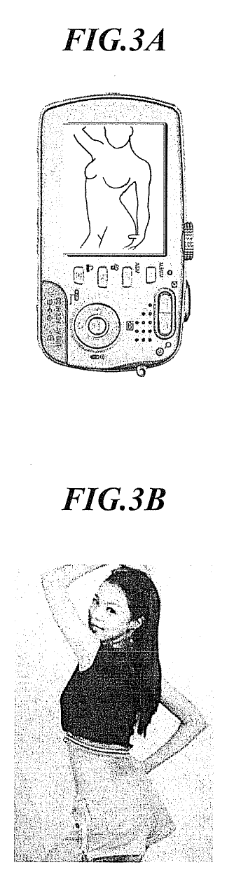

FIGS. 3A and 3B are illustrating examples of the recommendation of a pose and a motion by the recommending composition processing unit 106.

Referring to FIG. 3A, a user or a cameramen can refer to various poses and motions a model being presented on the display 108 of the digital image photographing apparatus and can recommend a specific pose and motion matched to a situation to the subject to be photographed. Accordingly, a monotonous image can be avoided and it is helpful to express dynamic and special contents.

FIG. 3B shows an example of a still image finally acquired after performance of the process illustrated in FIG. 3A.

Referring back to FIG. 1, the image control unit 110 functions to blur the background of the image photographed by the photographing unit 100. Such a background blurring is frequently applied to take a profile photo and a movie, and is implemented by two methods.

In a first method, optical characteristics are utilized to open an iris by a maximum degree and to make a focal distance maximum. These operations are electronically controlled so that the user can photograph in the optimum state.

A second method blurs the background separated based on the information about an subject region recognized by the recognizing unit 102. This method is not real in comparison to an optical method, but is very useful in an apparatus such as a small camera and the camera phone where it is difficult to obtain the blurring effect by using the optical characteristics.

The image compensating unit 112 compensates the image photographed by the photographing unit 110. In other words, the image compensating unit 112 compares a contrast ratio between the recognized subject and the surrounding background thereof to enhance the brightness of the subject to be higher than a preset brightness.

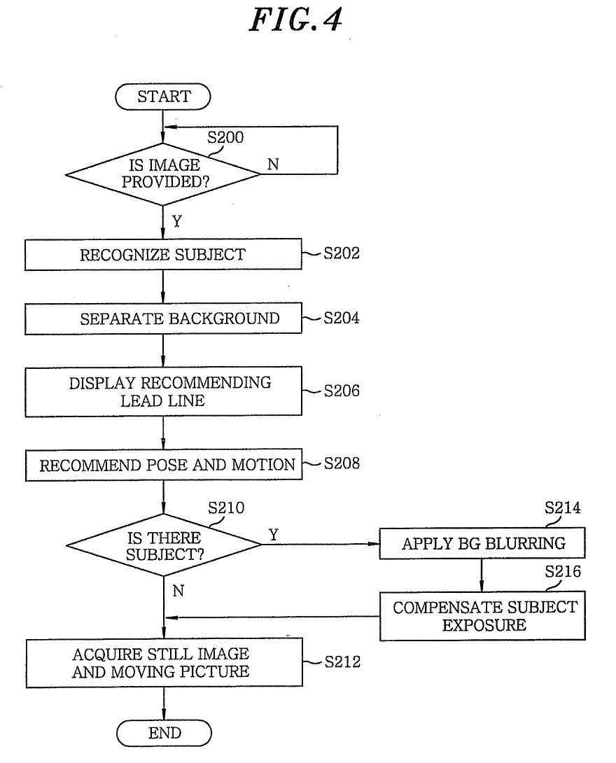

Hereinafter, a digital image photographing method in accordance with an embodiment of the present invention together with the above-mentioned configuration will be described with reference to a flowchart of FIG. 4 in detail.

Referring to FIG. 4, when an image is photographed by the photographing unit 100, the photographed image is provided to the recognizing unit 102 (S200).

The recognizing unit 102 analyzes the image provided from the photographing unit 100 to recognize a subject (human or a specific object) (S202). Thereafter, the image processing unit 104 performs a process of separating a foreground including the subject which is recognized by the recognizing unit 102 from the background (S204). In this case, the foreground may be separated from the background by using the edge detection algorithm and the image subtraction algorithm.

The recommending composition processing unit 106 recommends a specific pose/motion suitable for the situation to the subject as in FIG. 3A when the subject is dynamic objects (e.g., human or animal) (S208). By doing so, a monotonous image can be avoided and it is helpful to express dynamic and special contents.

It is determined that the image to be photographed has therein a subject (S210). If negative, an operation proceeds to S212 where a still image and a moving picture are acquired. However, if positive, an operation goes to S214 where a background blurring is performed by the image control unit 110 to blur the background thereby highlighting the subject.

In step S216, in case where brightness of the subject is relatively darker than that of the background, the image compensating unit 112 compensates an exposure of the subject to increase the brightness of the region of the recognized subject so that the subject become prominent and match to the background.

Finally, in step S212, a final image is obtained after the application of all of the background blurring and the exposure compensation for the recognized subject.

As described above, in accordance with the image photographing method and apparatus, a composition, and a pose and motion of the subject, suitable for the foreground and the background, are recommended so that the user can be serviced with a convenient image photographing function.

While the invention has been shown and described with respect to the embodiments, it will be understood by those skilled in the art that various changes and modifications may be made without departing from the scope of the invention as defined in the following claims.

What is claimed is:

1. A digital image photographing method comprising:
recognizing a subject by analyzing an image photographed by a digital image photographing apparatus;
separating the recognized subject from a background in the image;
displaying a recommending lead line of a rule of thirds on a display of the digital image photographing apparatus to help position the recognized subject on an intersection point of transversal and vertical trisectional lines; and
recommending a composition, a pose and a motion which are matched to the recognized subject and the background with reference to pre-recorded information about the composition, the pose and the motion.

2. The digital image photographing method of claim 1, wherein the subject is recognized by using a learning algorithm.

3. The digital image photographing method of claim 1, wherein said separating the recognized subject from a background in the image includes separating the recognized subject from the background of the image by using an image subtraction algorithm and an edge detection algorithm.

4. The digital image photographing method of claim 1, wherein, when the rule of thirds is applied and an optimal composition in which the recognized subject is matched to the background is acquired with reference to the recorded information about the subjects, the image having the optimal composition is automatically stored and displayed.

5. The digital image photographing method of claim 1, further comprising:
blurring the background to highlight the recognized subject; and
increasing brightness of a region of the recognized subject by applying a exposure compensation for the recognized subject.

6. The digital image photographing method of claim 5, wherein said blurring the background includes opening an iris by a maximal degree to make a focal distance maximum by utilizing optical characteristics of the digital image photographing apparatus, and blurring the background of the recognized subject.

7. A digital image photographing apparatus comprising:
a photographing unit for taking an image;
a recognizing unit for recognizing a subject from the image photographed by the photographing unit,
wherein the recognized subject is captured in a rectangular area;
an image processing unit for separating the recognized subject from a background;
a recommending composition processing unit for recommending a composition, a pose and a motion matched to the recognized subject and the background which are separated from each other by the image processing unit with reference to preset information; and
a display for displaying the image having the composition, the pose and the motion of the recognized subject recommended by the recommending composition processing unit.

8. The digital image photographing apparatus of claim 7, wherein the image processing unit displays a recommending lead line of a rule of thirds on the display to help move the rectangular area having the recognized subject captured therein until the rectangular area is positioned on an intersection point of transversal and vertical trisectional lines.

9. The digital image photographing apparatus of claim 7, wherein the recommending composition processing unit recommends the composition, the pose and the motion by considering conditions of the recognized subject and the background, and automatically records the image having the recommended composition, pose and motion when an optimal composition is acquired even though a user do not press a shutter and enable the user to select the recorded current image.

10. The digital image photographing apparatus of claim 7, further comprising:
an image control unit for blurring the background of the image photographed by the photographing unit; and
an image compensating unit for compensating the image photographed by the photographing unit.

11. The digital image photographing apparatus of claim 10, wherein the image control unit blurs the background and highlights the recognized subject by using an optical method of opening an iris by a maximal degree and of making a focal distance maximum, and a method of blurring the separated background.

12. The digital image photographing apparatus of claim 10, wherein the image compensating unit compares a contrast ratio between the recognized subject and the background to enhance brightness of the recognized subject to be higher than a preset brightness.
